(19) United States
(12) Patent Application Publication
(10) Pub. No.: US 2026/0061933 A1
(43) Pub. Date: Mar. 5, 2026

(54) TILT MECHANISM FOR DISPLAY MIRROR

(71) Applicant: Gentex Corporation, Zeeland, MI (US)

(72) Inventors: Jan Hafner, Gundelsheim (DE); Andreas Kraus, Bad Friedrichshall (DE)

(21) Appl. No.: 18/820,558

(22) Filed: Aug. 30, 2024

(51) Int. Cl. B60R 1/08

(52) U.S. Cl. CPC B60R 1/086

(57) ABSTRACT

An actuation mechanism for a vehicle mirror includes a mounting unit and a support plate coupleable with a rearview. A latch pin is slidably engaged with the support plate and with the mounting unit and moveable into a first retention position with respect to the support plate and the mounting unit that maintains the support plate in a first rotational position with respect to the mounting unit against the force of a first spring. The latch pin is further moveable into a second retention position with respect to the support plate and the mounting unit that maintains the support plate in a second rotational position with respect to the mounting unit against the force of the first spring. A release button is moveably coupled with the latch pin and moving the latch pin out of the second retention position on movement of the release button toward the mounting unit.

### BACKGROUND

The present disclosure relates generally to a full display mirror actuation mechanism and more particularly, relates to an actuation mechanism with a spring-biased toggle with a release button.

### SUMMARY

According to one aspect of the present invention, a vehicle rearview includes a substrate having a reflective surface thereon, a housing coupled with the substrate, and an actuation mechanism positioned within the housing. The actuation mechanism has a mounting unit, a support plate coupled with the substrate opposite the reflective surface and having a first end rotatably coupled with the mounting unit and a second end spaced from the first end, and a first spring abutting the mounting unit, at least partially received within a portion of the support plate, and urging the second end of the support plate away from the mounting unit. The actuation mechanism further includes a latch pin slidably engaged with the support plate and with the mounting unit and moveable into a first retention position with respect to the support plate and the mounting unit that maintains the support plate in a first rotational position at a first angle with respect to the mounting unit against the force of the first spring. The latch pin is further moveable into a second retention position with respect to the support plate and the mounting unit that maintains the support plate in a second rotational position at a second angle with respect to the mounting unit against the force of the first spring, the second angle being less than the first angle. A release button is moveably coupled with the latch pin and moveable outwardly from the housing with movement of the latch pin into the second position and moving the latch pin out of the second retention position on movement of the release button inwardly with respect to the housing.

According to another aspect of the present invention, a vehicle rearview includes a substrate having a reflective surface thereon, a housing coupled with the substrate, and an actuation mechanism positioned within the housing. The actuation mechanism includes a mounting unit, a support plate coupled with the substrate opposite the reflective surface and having a first end rotatably coupled with the mounting unit and a second end spaced from the first end, and a spring positioned between the support plate and the mounting unit and urging the second end of the support plate away from the mounting unit. The actuation mechanism further includes a latch pin slidably engaged with the support plate and with the mounting unit and moveable into a first retention position with respect to the support plate and the mounting unit that maintains the support plate in a first rotational position at a first angle with respect to the mounting unit against the force of the spring. The latch pin is further moveable into a second retention position with respect to the support plate and the mounting unit that maintains the support plate in a second rotational position at a second angle with respect to the mounting unit against the force of the spring, the second angle being less than the first angle. A release operably moves the latch pin out of the second retention position, a damper is operably coupled between the mounting unit and the support plate. The damper slows movement of the support plate into the first rotational position from the second rotational position under force of the first spring.

According to another aspect of the present invention, an actuation mechanism for a vehicle mirror includes a mounting unit, a support plate coupleable with a rearview substrate and having a first end rotatably coupled with the mounting unit and a second end spaced from the first end, and a first spring positioned between the support plate and the mounting unit and urging the second end of the support plate away from the mounting unit. A latch pin is slidably engaged with the support plate and with the mounting unit and moveable into a first retention position with respect to the support plate and the mounting unit that maintains the support plate in a first rotational position at a first angle with respect to the mounting unit against the force of the first spring. The latch pin is further moveable into a second retention position with respect to the support plate and the mounting unit that maintains the support plate in a second rotational position at a second angle with respect to the mounting unit against the force of the first spring. The second angle is less than the first angle. A release button is moveably coupled with the latch pin and moving the latch pin out of the second retention position on movement of the release button toward the mounting unit.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a front perspective view of a vehicle rearview according to an aspect of the disclosure;

FIG. 2 is a rear perspective view of the rearview;

FIG. 3 is an exploded view of the rearview including an internal actuation mechanism thereof;

FIG. 4 is a perspective view of a portion of a vehicle interior including the rearview;

FIG. 5 is a front perspective view of the actuation mechanism with a support plate in an upwardly-angled first rotational position;

FIG. 6 is a right side view of the actuation mechanism with the support plate in the first rotational position;

FIG. 7 is a perspective detail view of the actuation mechanism with the support plate in the first rotational position;

FIG. 8 is a further perspective detail view of the actuation mechanism with the support plate in the first rotational position;

FIG. 9 is a still further perspective detail view of the actuation mechanism with the support plate in the first rotational position;

FIG. 10 is a right side view of the actuation mechanism with the support plate in a transitional position;

FIG. 11 is a perspective detail view of the actuation mechanism with the support plate in a downwardly-rotated second rotational position;

FIG. 12 is a further perspective detail view of the actuation mechanism with the support plate in the second rotational position;

FIG. 13 is a cross-section view of the actuation mechanism with the support plate in the second rotational position;

FIG. 14 is a further is a cross-section view of the actuation mechanism with the support plate in the second rotational position;

FIG. 15 is a further perspective detail view of the actuation mechanism with the support plate in the second rotational position;

FIG. 16 is a bottom perspective view of the rearview with the actuation mechanism with the support plate in the second rotational position; and

FIG. 17 is a perspective view of the actuation mechanism showing a damper device included therein.

### DETAILED DESCRIPTION OF EMBODIMENTS

The present illustrated embodiments reside primarily in combinations of method steps and apparatus components related to a vehicle rearview. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

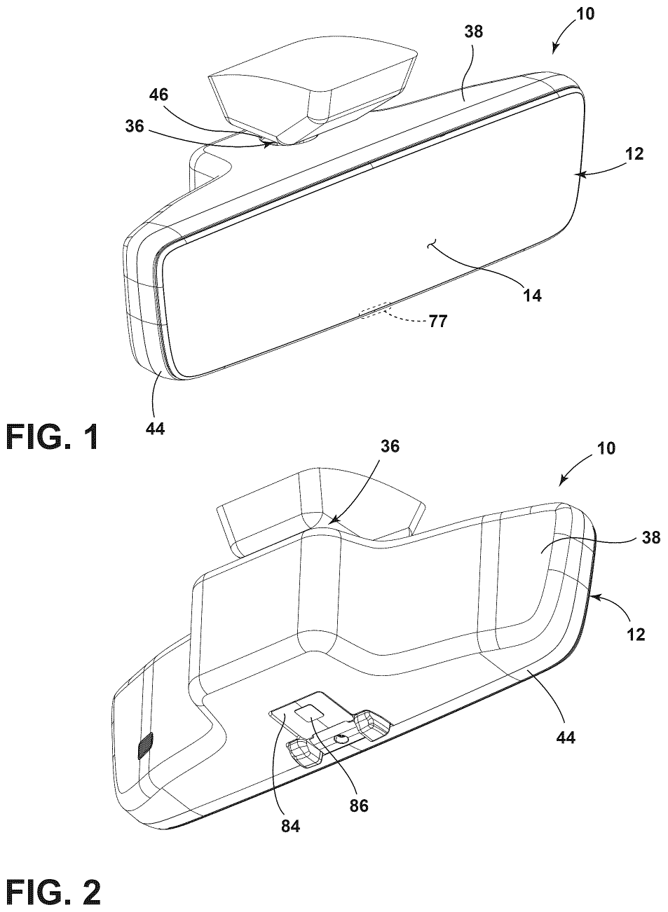

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed transportation rack in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about,” “approximately,” or “substantially,” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

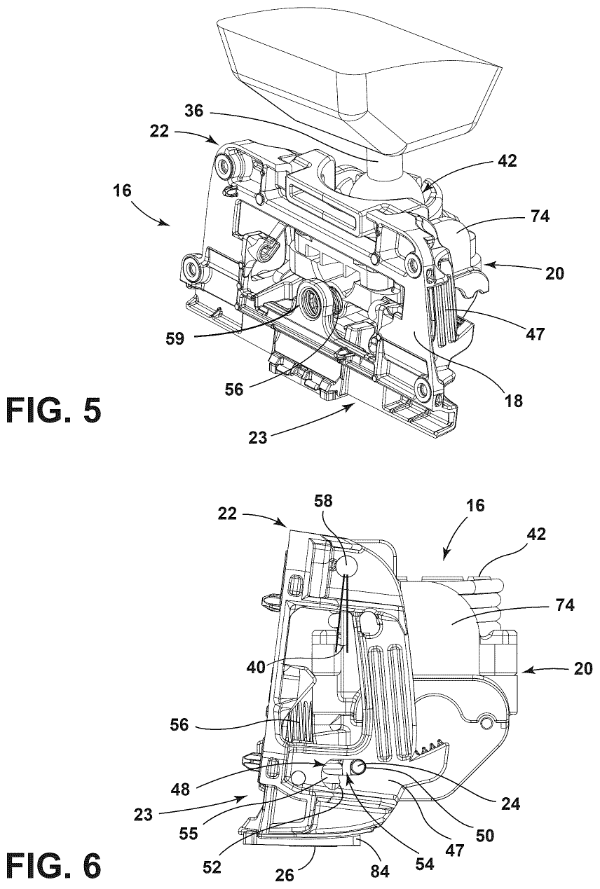

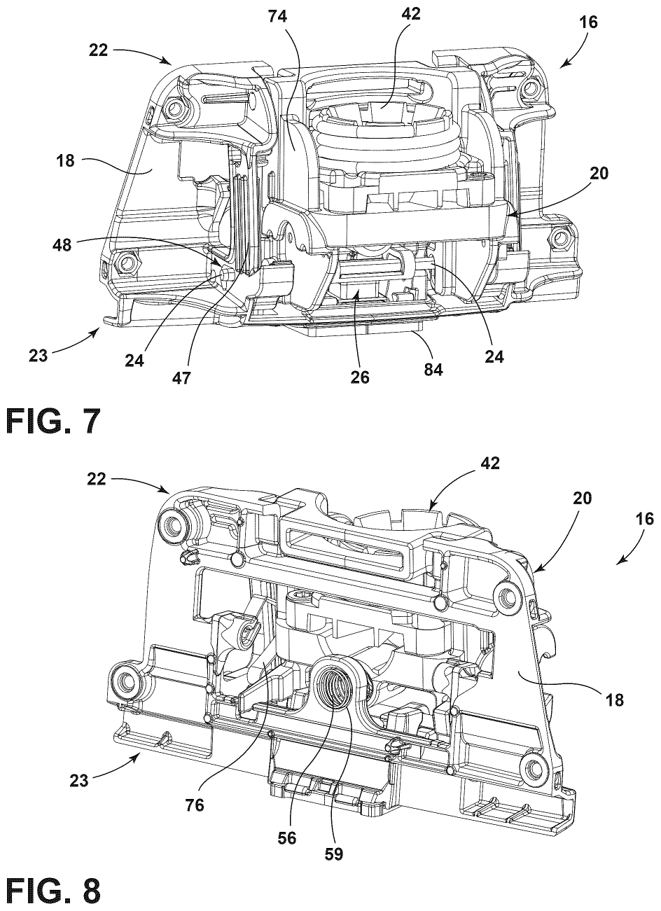

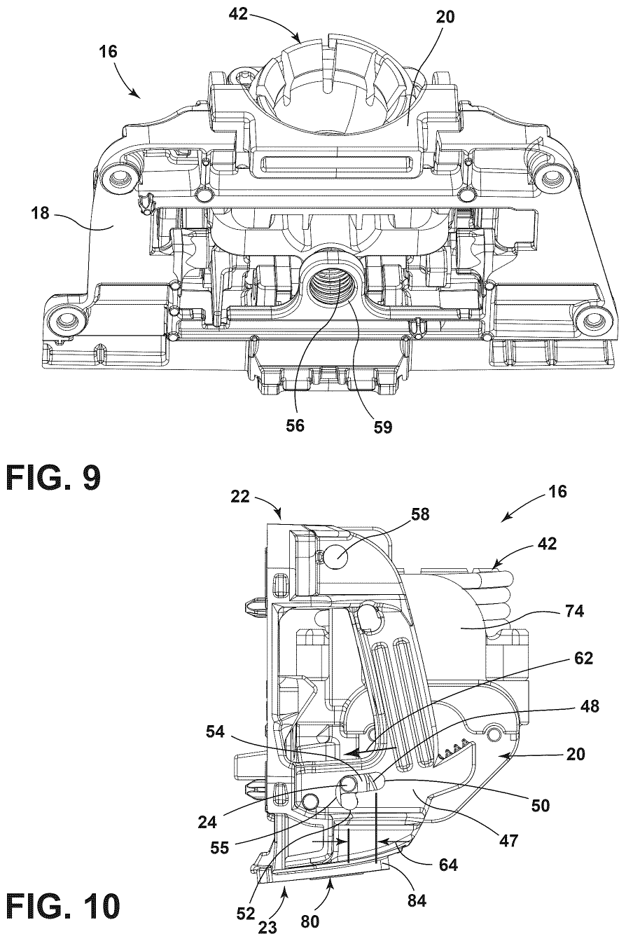

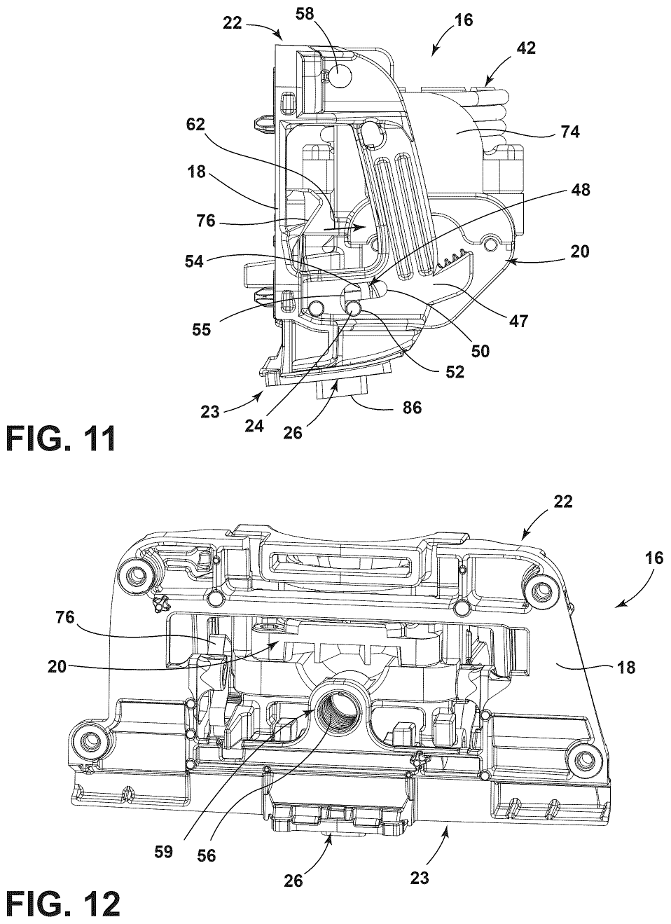

Referring to FIGS. 1-17, reference numeral 10 generally designates a vehicle rearview, which may be referred to simply as a “rearview”. The rearview 10 includes a substrate 12 having a reflective surface 14 thereon, a housing 38 coupled with the substrate 12, and an actuation mechanism 16 positioned within the housing 38. The actuation mechanism 16 has a mounting unit 20, a support plate 18 coupled with the substrate 12 opposite the reflective surface 14 and having a first end 22 rotatably coupled with the mounting unit 20 and a second end 23 spaced from the first end 22, and a first spring 56 abutting the mounting unit 20, at least partially received within a portion of the support plate, and urging the second end 23 of the support plate 18 away from the mounting unit 20. The actuation mechanism 16 further includes a latch pin 24 slidably engaged with the support plate 18 and with the mounting unit 20 and moveable into a first retention position (FIG. 5) with respect to the support plate 18 and the mounting unit 20 that maintains the support plate 18 in a first rotational position (FIG. 5) at a first angle 40 with respect to the mounting unit 20 against the force of the first spring 56. The latch pin 24 is further moveable into a second retention position (FIG. 11) with respect to the support plate 18 and the mounting unit 20 that maintains the support plate 18 in a second rotational position (FIG. 11) at a second angle 40′ with respect to the mounting unit 20 against the force of the first spring 56 with the second angle 40′ being less than the first angle 40. A release button 26 is moveably coupled with the latch pin 24 and is moveable outwardly from the housing 38 with movement of the latch pin 24 into the second position and moving the latch pin 24 out of the second retention position on movement of the release button 26 inwardly with respect to the housing 38.

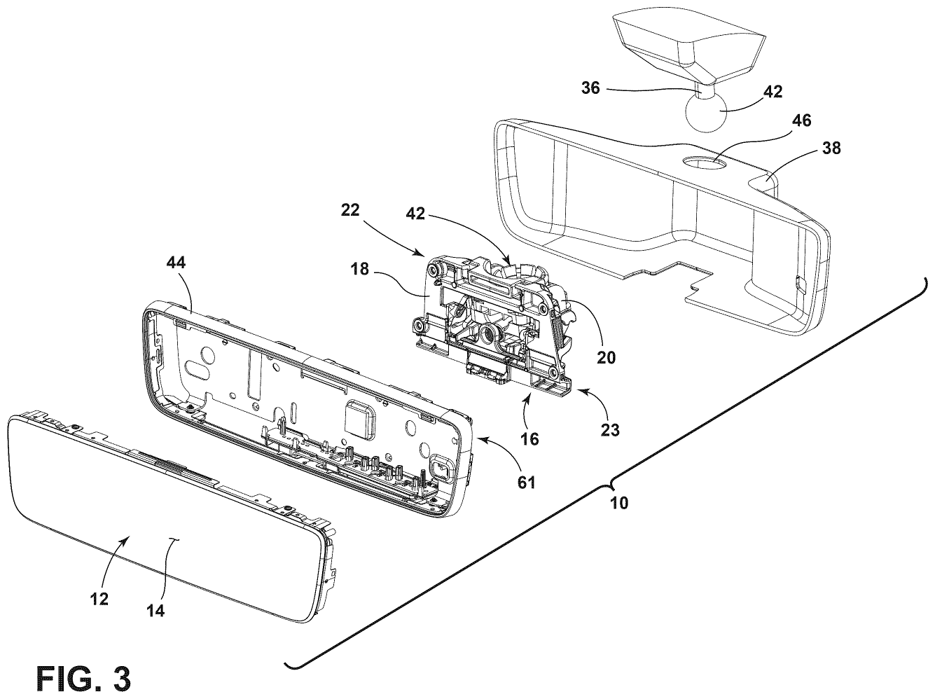

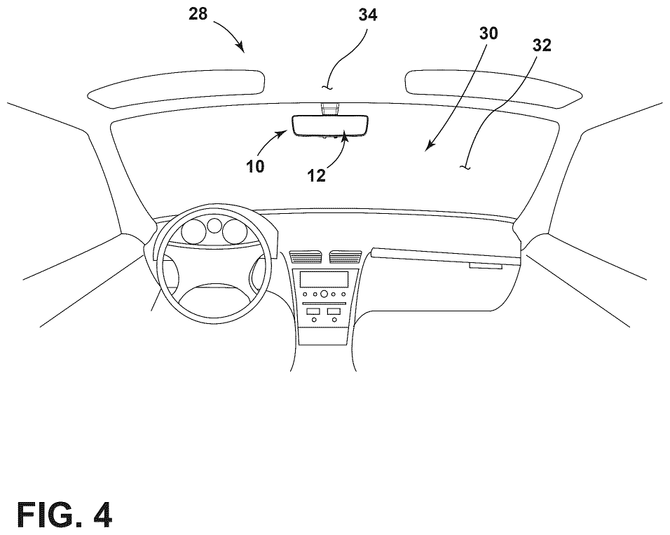

As shown in FIG. 4, rearview 10 can be used in connection with a vehicle 28, particularly within interior 30 thereof. In particular, rearview 10 can be mounted adjacent a windshield 32 of vehicle 28 either by attachment with the windshield 32 itself or to an internal component adjacent headliner 34 (which may include a portion of the vehicle frame, a vehicle panel, or other support structure, for example). Such attachment is achieved by a mounting arm 36 that is coupled with vehicle 28, as described, and couples with actuation mechanism 16 (FIG. 3), as explained further below, by extending through an opening 46 (FIG. 3) housing 38 of rearview 10 that encloses the various internal structures thereof opposite and surrounding substrate 12. The support of mounting unit 20 (FIG. 3) by mounting arm 36 and the above-described coupling of support plate with mounting unit 20 and with substrate 12 serves to position substrate 12 in a desired position within interior 30. In particular, substrate 12 is generally configured to present an image (reflected or video, as described below) to a driver of vehicle 28 of the view to the rear of vehicle 28 and, accordingly, may be adjustable by movement of substrate 12 with respect to mounting arm 36. In one embodiment, substrate 12 can be in the form of a prism mirror substrate of a generally transparent material having a tapered shape and an internal reflective surface. In this manner, the above-described alternate engagement of toggle latch 24 in the first (FIG. 6) and second (FIG. 11) positions can, as described further below, cause rotation of substrate 12 between an upwardly-angled position, in which the highly-reflective surface reflects an image of the headliner 34 (the outer, polished surface reflecting an image toward the rear of the vehicle 28) and a downwardly-directed position, in which the image reflected off of the highly-reflective surface is oriented toward the rear of the vehicle 28 so as to be visible by the driver. In general, this arrangement allows for separate day and night modes in which the upwardly-directed position presents a dimmer image to the driver, by way of the polished surface instead of the mirror surface.

In another embodiment, substrate 12 may include a video display panel along a portion or an entirety thereof such that rearview 10 is what may be referred to as a full-display mirror. Substrate 12, when including such a display, may be referred to herein as “display substrate 12” and may be capable of displaying a simulated mirror-image of the view to the rear of vehicle 28 (that may be captured by an appropriately-positioned video camera or the like) when the display is in an active state. Such an image may generally replicate that which would be available from a typical reflective mirror and can be supplemented with other information presented on display substrate 12. In combination with such display substrate 12, reflective surface 14 (FIG. 1) may overlie the display as a coating or separate element having properties to both provide a reflected image as well as to permit a video image of display substrate 12 to be visible therethrough.

The presence of reflective surface 14 permits substrate 12 to be used as a standard rearview mirror (i.e., without the need to view the displayed image) when the display is in an inactive state, which may occur when the related vehicle 28 is not running or when power to the display substrate 12 is interrupted, for example. When in the active state, however, the presence of the reflective surface 14 over display substrate 12 can cause the image reflected by reflective surface 14 to compete with an image presented on display substrate 12. To alleviate such image competition, substrate 12 can be positioned such that reflective surface 14 reflects an image of the headliner 34 toward the driver. Because vehicle headliners are of generally consistent, non-reflective material, such an image may compete less with the video image of display substrate 12.

Rearview 10, by way of the actuation mechanism 16 (FIG. 3), can allow for a user to control repositioning of substrate 12 between the above-described upwardly- and downwardly-directed positions for the desired use of rearview 10, depending on the type of substrate 12. As discussed further below, this movement corresponds with movement of support plate 18 about first end 22 with respect to mounting unit 20. Because substrate 12 is fixed with respect to support plate 18, such movement results in movement of substrate 12 through a predetermined angle relative to mounting arm 36. In an example, such movement can be through a downward (i.e., away from headliner 34) angle 40 (FIG. 6) of between about 5° and 10°, and in one embodiment about 7°.

As can be seen in FIGS. 2 and 3, mounting arm 36 can couple with actuation mechanism 16 by attachment with mounting unit 20 by a ball and socket coupling 42. This arrangement can allow for the above-mentioned general adjustment of substrate 12 so as to position substrate 12 at a desired position with respect to the driver for viewing of the image viewable on substrate 12 in, for example a “day” mode. As described further below with respect to FIGS. 10 and 11, movement of the support plate 18 and latch pin 24 from the respective first positions to the respective second positions, for example, can correspond with movement of both housing 38 and substrate 12 relative to mounting unit 20, while mounting unit 20 remains generally static. Such movement can allow substrate 12 to toggle between the positions for substrate 12 provided by the first and second retention positions of actuation mechanism 16 without changing the positions themselves.

Referring to FIGS. 1-3, housing 38 is shown in the form of a single-piece unit and can be made from a single piece of injection molded plastic or the like, although other materials are possible. In the depicted embodiment, support plate 18 can be coupled with housing 38 indirectly by coupling the housing 38 with the bezel 44 that surrounds the substrate 12, with the support plate 18 being coupled with the substrate 12 on an interior thereof. In another example, support plate 18 may be affixed with housing 38, which may support the substrate 12 by connection of the housing 38 with the bezel 44. In either arrangement, the bezel may be eliminated and the substrate 12 coupled directly with housing 38 (including by various clips, brackets, etc. associated with the structure comprising substrate 12). In either example, housing 38 is structured so that an interior is defined therein and is of a sufficient depth to retain internal structures of rearview 10, including actuation mechanism 16, and other related structures, such as those related to a display substrate 12.

As shown in FIGS. 5-9, support plate 18 includes two laterally-spaced ribs 47 that are positioned on opposite sides of mounting unit 20. Each of the ribs 47 defines a respective one of a first track 48 with the support plate 18 slidably receiving the latch pin 24 by sliding engagement of the latch pin 24 within each of the first tracks 48. In the illustrated implementation, opposite ends of the latch pin 24 are received in respective ones of the first tracks 48, which may provide a stable latching arrangement, as can be appreciated by the description below. Each first track 48 is generally identical (including by the ribs 47 being mirror images of each other) and defines first 50 and second 52 ends that correspond with the above-mentioned first and second positions of latch pin 24, respectively. In particular, the first end of the first track 48 corresponds with the first retention position of the latch pin, as shown in FIG. 6, a straight portion 54 extends away from the first end 50 generally parallel with the second end 52 of the support plate 18 (i.e., in a direction perpendicular to the inner surface of the substrate 12 (+/−5°). A curved portion 55 of the first track 48 extends toward the second end 52 of the support plate 18. As shown, the first end 50 and the second end 52 can be respectively open to the first straight portion 54 and the curved portion 55 in a first direction 62 disposed toward the substrate 12. In this manner, abutment of the latch pin 24 with the respective first end 50 and second end 52 can oppose the force of the spring 56 to maintain the corresponding position of the support plate 18. Accordingly, a distance 64 between the first end 50 and the second end 52 in the first direction 62 can correspond with the movement angle 40, (i.e., in relation to a corresponding vertical distance between the first track 48 and the hinge joint 58 coupling the support plate 18 to the mounting unit 20).

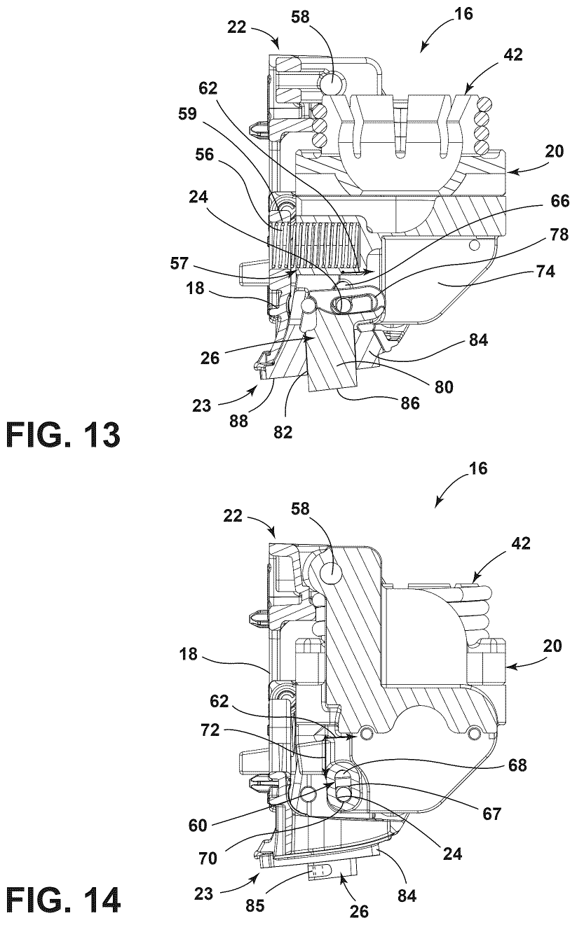

As further shown in FIG. 6 (as well as FIGS. 13 and 14), the mounting unit 20 can define a second track 66 having a straight portion 67 immediately connected with and extending between a first end 68 and a second end 70. As shown, the second track 66 extends in a second direction 72 (FIG. 14), that is perpendicular to the first direction 62 in which the straight portion 54 of the first track 48 extends. In this manner, the first end 68 of the second track 66 aligns with the first end 50 of the first track 48 to accommodate the movement of the latch pin 24 into the first retention position (FIG. 6). Similarly, the second end 70 of the second track 66 aligns with the second end 52 of the first track 48 when the latch pin 24 is in the second retention position (FIG. 11). Notably, the orientation of the second track 66 in the second direction 72 is such that the latch pin 24 is fixed in direction 62 with respect to the mounting unit 20, which serves to maintain the support plate 18 in the respective first and second retention positions in cooperation with the configuration of the first track 48, as discussed above. In a similar manner to the first track 48, the mounting unit 20 can include two identically-configured second tracks 66 defined in two mirror-image ribs 74 on opposite sides of the ball coupling 42 that are positioned parallel to and inside of the ribs 47 defined on the support plate 18.

As shown in FIGS. 5 and 6, the above mentioned spring 56 can be in the form of one or more primary springs 56 positioned between and operably engaged with each of mounting unit 20 and support plate 18. As shown in FIG. 13, in the illustrated example, the primary spring abuts the mounting unit 20 by being received in a cavity 57 formed in the mounting unit 20 and extending to a closed end of the cavity 57. As further shown in FIG. 5, the spring is received within an opening 59 in the support plate 18 that serves to maintain a position of the primary spring 56 with respect thereto such that the primary spring abuts and acts against an interior surface 61 of the bezel 44 to indirectly urge the second end 23 of the support plate 18 away from the mounting unit 20 by acting on the bezel 44. The primary spring 56 in the illustrated example is a coil spring that operates under compression in the position between mounting unit 20 and the bezel 44. In this manner, in the upwardly-angled first position illustrated in FIGS. 5-9, primary spring 56 indirectly urges support plate 18 away from second end 23 of mounting unit 20, which is constrained in rotational movement about hinge 58 that secures first end 22 of mounting unit 20 with support plate 18. In other implementations, the opening 59 can be closed such that the primary spring 56 acts directly on the support plate 18, a single primary spring 56 in the form of a leaf spring or the like may be substituted for the illustrated coil spring, or one or more torsion springs may be positioned adjacent hinge 58. The force provided by primary springs 56 helps to maintain latch pin 24 within the first end 50 of first track 48 corresponding with the depicted first position. As discussed above, the latch pin 24 is constrained in a constant position in the first direction 62 with respect to the mounting unit 20 and the corresponding end of primary spring 56 such that the support plate 18 is urged outward with respect to the mounting unit 20, forcing the respective first end 50 or second end 52 of the first track 48 into contact with the latch pin 24, with the interaction between the latch pin 24, the first track 48 and the second track 66 maintaining the corresponding position of support plate 18 with respect to the mounting plate.

As discussed further below, movement of support plate 18 into the downwardly angled second position corresponding to the second retention position of latch pin 24, shown in FIG. 11, requires a force to be applied to an area of rearview 10 adjacent second end 23 of mounting unit, such as within area 77 of bezel 44 depicted in FIG. 1. To allow for such movement without changing the positioning of mounting unit 20 about mounting arm 36, the force required for such compression of primary spring 56 should be less than the internal friction within ball and socket coupling 42, as overcoming such friction will cause repositioning of coupling 42. Even further, it may be desirable to configure actuation mechanism 16 in such a manner that a force on housing 38, including in area 77 can be sufficiently low to provide easy movement of support plate 18 (and, accordingly, substrate 12) into the downwardly angled position shown in FIG. 16. Accordingly, the force provided by primary springs 56 may be well under the internal friction of coupling 42. As shown in FIG. 10, a rearward force applied in area 77 can rotate substrate 12 and support plate 18 about the hinge 58 such that the second end 23 of the support plate moves toward the mounting unit 20 under compression of primary spring 56. As shown, this causes relative movement of the latch pin 24 away from first end 50 of the first track 48 and into the straight portion 54. While the latch pin 24 is in the straight portion 54, the latch pin 24 will remain in or appreciably near the first end 68 of the second track 66. When such rotational movement continues, the latch pin 24 will reach the curved portion 55, as shown in FIG. 11. Continuing motion will move the latch pin 24 through the curved portion 55, as permitted by movement of the latch pin 24 downward within the second track 66 toward the second end 70, aided by the extension force of spring 76 (FIG. 12). As can be appreciated, the curved portion 55 extends past the second end 52 of the first track 48 such that, for the latch pin 24 to reach the second retention position, as shown in FIG. 11, the support plate 18 is rotated slightly past the second position. This movement causes the latch pin 24 to move through the curved portion 55 to reach the second end 52 of the first track 48, along with the second end 70 of the second track 66. When the force is released, the support plate 18 moves back in direction 62 until the latch pin 24 moves into contact with the second end 52 of the first track 48, which maintains the support plate 18 in the second, downwardly rotated position, with latch pin 24 in the second retention position (FIG. 11).

In this manner, rearview mirror may be retained in the position of substrate 12 corresponding with the positioning of latch pin 24 in the depicted first position against inadvertent movement, such as that caused by intentional repositioning of substrate 12 about mounting arm 36 by intentional force on housing 38. When it is desired to move the substrate 12 into the downwardly angled first retention position, a force can be applied on area 77 of bezel 44 (FIG. 1). In this manner, the force required to move support plate 18 in direction 62 against the above-mentioned combined forces should be less than the internal friction of coupling 42 to prevent movement of mounting unit 20 about mounting arm 36 (FIG. 5).

To facilitate movement of the latch pin 24 downward through curved portion 55 of the first track 48 and, simultaneously, through the straight portion 67 of the second track 66, the actuation mechanism 16 can further include a latch spring 76. As shown, the latch spring 76 can be coupled with the support plate 18 and can extend generally downwardly to oppositely couple with the latch pin 24. In various specific implementations, the spring 76, which can be a metallic leaf spring or the like, can be configured to compress with movement of the latch pin 24 into the first retention position, with the corresponding extension force of the spring 76 exerting a force against the latch pin 24 to urge the latch pin 24 toward the second retention position.

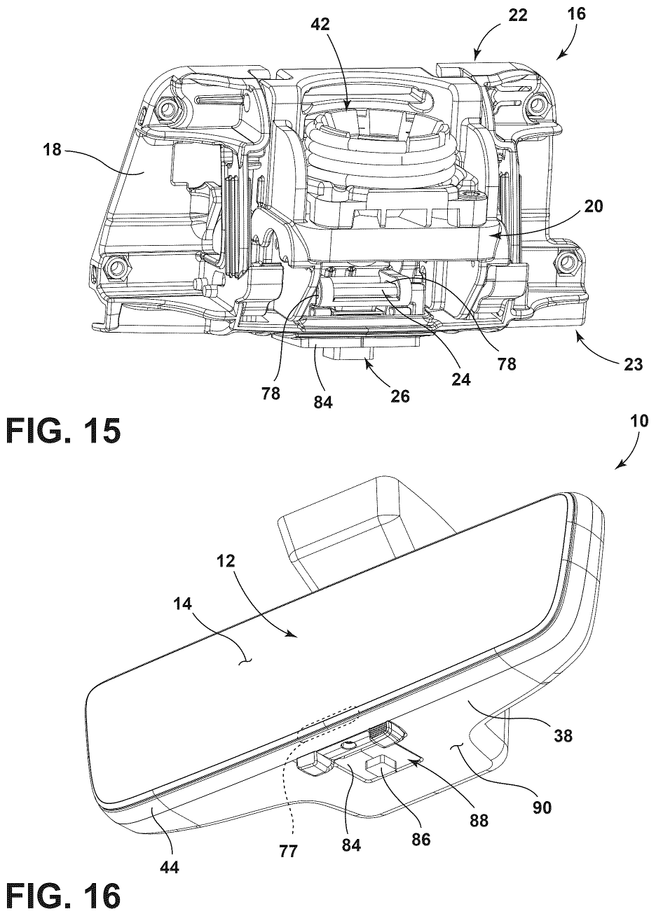

As discussed above, the release button 26 is provided to urge the latch pin 24 out of the second retention position to allow for a desired movement of the support plate 18 back to the first (upwardly-angled) position described above. As particularly shown in FIGS. 13 and 15, the release button 26 can be coupled with the latch pin 24 by way of a third track 78. In this manner, the release button 26 is retained in the retracted position with respect to the housing when the latch pin is in the first retention position (shown in FIG. 6). As shown in FIGS. 11, 13, and 14, the release button 26 moves outwardly with respect to the housing 38 into an extended position with movement of the latch pin 24 into the second retention position. In the illustrated implementation, the release button 26 includes a body 80 that extends through a corresponding aperture 82 in an exterior extension portion 84 of the support plate 18. As shown in FIG. 15, the exterior extension portion 84 fills an open area between the bezel 44 and the housing 38 along the lower surface of the housing 38 such that extension of the button body 80 out of the aperture 82 effects movement of the release button 26 outward with respect to the housing 38, as described above. Notably, as the release button 26 is constrained in rotational movement with the support plate 18, the third track 78 is configured to extend along an arc centered about hinge 58 through a distance to accommodate movement of the release button 26 with the support plate 18, while the latch pin 24 remains in a consistent position with respect to the hinge 58 (i.e., within the first end 68 of the second track 66). When the latch pin 24 moves simultaneously through the curved portion 55 of the first track 48 and through the straight portion 67 of the second track 66, the release button 26 is moved to the extended position (FIGS. 11, 13, and 14).

As shown in FIG. 16, the extension portion 84 of the support plate 18 has an outer surface 90 surrounding the aperture 82 through which the release button 26 extends. The outer surface 88 can extend within or along the corresponding outer surface 90 of the housing 38. The release button 26 can define a lower surface 86 that can be flush with the outer surface 88 of the extension portion 84 and/or the adjacent outer surface 90 of the housing 38 when the release button 26 is in the retraced position (FIG. 6). In this manner, the release button 26 is maintained out of view of the user when the substrate 12 is in the upwardly-angled position (i.e., corresponding with use of a display substrate 12). Notably, this condition corresponds with movement by directly pushing on the bezel 44, for example, such that the release button 26 is not needed. The release button 26 can include a visibility marking 85 (FIG. 14), such as having a signal color, such as green or the like around the body 80 above the outer surface 88. This may serve to draw attention to the presence of the release button 26, indicating orientation of the substrate 12 and support plate 18 in the second rotational position.

Accordingly, when the release button is pressed (in a direction toward extension portion 84), the third track 78 exerts an upward force against the latch pin 24. This force opposes the force of the latch spring 76. Additionally, the force on the latch pin 24 acts against the force of primary spring 56 to move the second end 52 of the support plate 18 toward the mounting unit 20 slightly such that the latch pin 24 can move through the curved portion 55 away from the second end of the first track 48. Once the latch pin 24 moves past the halfway point of the curved portion 55, the primary spring 56 will force the second end 23 of the support plate 18 away from the mounting unit 20 such that the latch pin 24 moves through the remainder of the curved portion 55, through the straight portion 54 and into contact with the first end 50 of the first track 48. Notably, this movement corresponds with movement of latch pin 24 through the straight portion 67 of the second track 66 to the first end 68 thereof, which retracts the release button 26 inward with respect to the housing 38 such that the lower surface 86 is again flush with the extension surface 88.

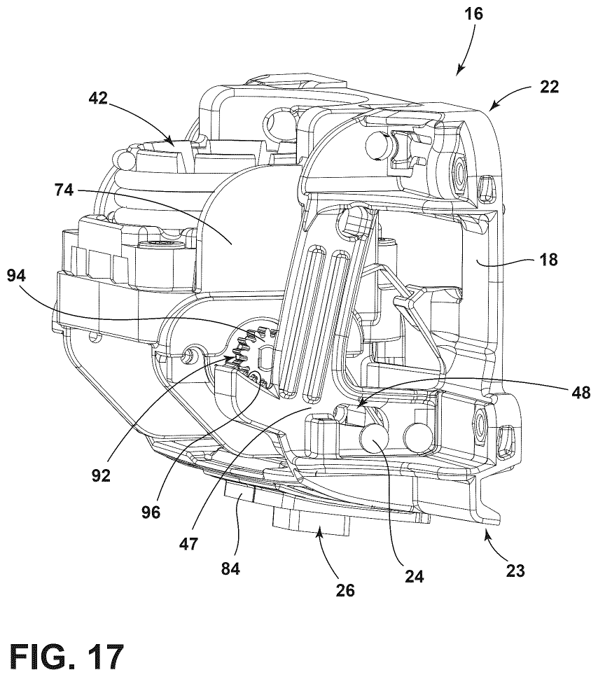

As shown in FIG. 17, the actuation mechanism 16 can further include a damper 92 operably coupled between the mounting unit 20 and the support plate 18. The damper 92 can act to slow the above-described movement of the support plate 18 into the first rotational position from the second rotational position (shown in FIG. 17) under force of the first spring, as discussed above. In the illustrated implementation, the damper 92 includes a gear 94 that engages with a rack 96 integral with the support plate 18. In this manner, the damper can be configured to oppose rotation of the damper in a manner proportional with one of a force acting on the gear 94 or a rotational velocity imparted on the gear 94 by the rack. In this manner, the damper 92 acts to exert an opposing force on the rack 96 by way of the gear 94 to slow movement of the support plate 18 to, for example about 5° per second (+/−5%).

The invention disclosed herein is further summarized in the following paragraphs and is further characterized by combinations of any and all of the various aspects described therein.

According to another aspect of the present disclosure, a vehicle rearview includes a substrate having a reflective surface thereon, a housing coupled with the substrate, and an actuation mechanism positioned within the housing. The actuation mechanism has a mounting unit, a support plate coupled with the substrate opposite the reflective surface and having a first end rotatably coupled with the mounting unit and a second end spaced from the first end, and a first spring abutting the mounting unit, at least partially received within a portion of the support plate, and urging the second end of the support plate away from the mounting unit. The actuation mechanism further includes a latch pin slidably engaged with the support plate and with the mounting unit and moveable into a first retention position with respect to the support plate and the mounting unit that maintains the support plate in a first rotational position at a first angle with respect to the mounting unit against the force of the first spring. The latch pin is further moveable into a second retention position with respect to the support plate and the mounting unit that maintains the support plate in a second rotational position at a second angle with respect to the mounting unit against the force of the first spring, the second angle being less than the first angle. A release button is moveably coupled with the latch pin and moveable outwardly from the housing with movement of the latch pin into the second position and moving the latch pin out of the second retention position on movement of the release button inwardly with respect to the housing.

In the vehicle rearview of ¶ [0048], the latch pin can be slidably engaged with a first track in the support plate, the first track having a first end corresponding with the first retention position of the latch pin, a straight portion extending away from the first end generally parallel with the second end of the support plate, a curved portion extending toward the second end of the support plate, and a second end adjacent the curved portion and corresponding with the second retention position of the latch pin.

In the vehicle rearview of ¶ [0049], the first end and the second end can be respectively open to the first straight portion and the curved portion in a first direction disposed toward the substrate.

In the vehicle rearview of any of ¶¶ [0049] or [0050], the mounting portion can define a second track defining a straight portion immediately connected with a first end and a second end, the first end of the second track being alignable with the first end of the first track with the latch pin in the first retention position, and the second end of the second track being alignable with the second end of the first track with the latch pin in the second retention position.

In the vehicle rearview of any of ¶¶ [0048] to [0051], the release button can be coupled with the latch pin so as to be retained in a retracted position with respect to the housing when the latch pin is in the first retention position and to be moved outwardly with respect to the housing into an extended position with movement of the latch pin into the second retention position.

In the vehicle rearview of ¶ [0052], the release button can define a lower surface, the housing can define an outer surface with an aperture, the release button moveably positioned within the aperture, and the lower surface of the release button can be flush with the outer surface of the housing when the release button is in the retraced position.

In the vehicle rearview of any of ¶¶ [0052] or [0053], the release button can include a visibility marking indicating orientation of the support plate in the second rotational position.

The vehicle rearview of any of ¶¶ [0048] to [0054] can further include a damper operably coupled between the mounting unit and the support plate, the damper slowing movement of the support plate into the first rotational position from the second rotational position under force of the first spring.

The vehicle rearview of any of ¶¶ [0048] to [0055] can further include a second spring coupled with the latch pin to urge the latch pin into the second retention position.

In the vehicle rearview of ¶ [0056], the inward movement of the release button relative to the housing can move the latch pin out of the second retention position against the force of the second spring.

In the vehicle rearview of any of ¶¶ [0048] to [0057], the substrate can include a display panel having an active state and an inactive state, the first rotational position of the support plate can correspond with the active state of the display panel, and the second rotational position of the support plate can correspond with the inactive state of the display panel.

According to yet another aspect, a vehicle rearview includes a substrate having a reflective surface thereon, a housing coupled with the substrate, and an actuation mechanism positioned within the housing. The actuation mechanism includes a mounting unit, a support plate coupled with the substrate opposite the reflective surface and having a first end rotatably coupled with the mounting unit and a second end spaced from the first end, and a spring abutting the mounting unit, at least partially received within a portion of the support plate, and urging the second end of the support plate away from the mounting unit. The actuation mechanism further includes a latch pin slidably engaged with the support plate and with the mounting unit and moveable into a first retention position with respect to the support plate and the mounting unit that maintains the support plate in a first rotational position at a first angle with respect to the mounting unit against the force of the spring. The latch pin is further moveable into a second retention position with respect to the support plate and the mounting unit that maintains the support plate in a second rotational position at a second angle with respect to the mounting unit against the force of the spring, the second angle being less than the first angle. A release operably moves the latch pin out of the second retention position, a damper is operably coupled between the mounting unit and the support plate. The damper slows movement of the support plate into the first rotational position from the second rotational position under force of the first spring.

In the vehicle rearview of ¶ [0059], the release can be a button moveably coupled with the latch pin and moveable outwardly from the housing with movement of the latch pin into the second position and moving the latch pin out of the second retention position on movement of the release button inwardly with respect to the housing.

In the vehicle rearview of ¶ [0060], the release button can be coupled with the latch pin so as to be retained in a retracted position with respect to the housing when the latch pin is in the first retention position and to be moved outwardly with respect to the housing into an extended position with movement of the latch pin into the second retention position.

In the vehicle rearview of ¶ [0061], the release button can define a lower surface, the housing can define an outer surface with an aperture, the release button can be moveably positioned within the aperture, and the lower surface of the release button can be flush with the outer surface of the housing when the release button is in the retraced position.

In the vehicle rearview of any of ¶¶ [0059]-[0062], the latch pin can be slidably engaged with a first track in the support plate, the first track having a first end corresponding with the first retention position of the latch pin, a straight portion extending away from the first end generally parallel with the second end of the support plate, a curved portion extending toward the second end of the support plate, and a second end adjacent the curved portion and corresponding with the second retention position of the latch pin.

In the vehicle rearview of ¶ [0063], the first end and the second end can be respectively open to the first straight portion and the curved portion in a first direction disposed toward the substrate.

In the vehicle rearview of any of ¶¶ [0063] or [0064], the mounting portion can define a second track defining a straight portion immediately connected with a first end and a second end, the first end of the second track being alignable with the first end of the first track with the latch pin in the first retention position, and the second end of the second track being alignable with the second end of the first track with the latch pin in the second retention position.

The vehicle rearview of any of ¶¶ [0059] to [0065] can further include a second spring coupled with the latch pin to urge the latch pin into the second retention position, and the inward movement of the release button relative to the housing can move the latch pin out of the second retention position against the force of the second spring.

According to yet another aspect, an actuation mechanism for a vehicle mirror includes a mounting unit, a support plate coupleable with a rearview substrate and having a first end rotatably coupled with the mounting unit and a second end spaced from the first end, and a first spring abutting the mounting unit, at least partially received within a portion of the support plate, and urging the second end of the support plate away from the mounting unit. A latch pin is slidably engaged with the support plate and with the mounting unit and moveable into a first retention position with respect to the support plate and the mounting unit that maintains the support plate in a first rotational position at a first angle with respect to the mounting unit against the force of the first spring. The latch pin is further moveable into a second retention position with respect to the support plate and the mounting unit that maintains the support plate in a second rotational position at a second angle with respect to the mounting unit against the force of the first spring. The second angle is less than the first angle. A release button is moveably coupled with the latch pin and moving the latch pin out of the second retention position on movement of the release button toward the mounting unit.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A vehicle rearview, comprising:
a substrate having a reflective surface thereon;
a housing coupled with the substrate; and
an actuation mechanism positioned within the housing and including:
a mounting unit;
a support plate coupled with the substrate opposite the reflective surface and having a first end rotatably coupled with the mounting unit and a second end spaced from the first end;
a first spring abutting the mounting unit, at least partially received within a portion of the support plate, and urging the second end of the support plate away from the mounting unit;
a latch pin slidably engaged with the support plate and with the mounting unit and moveable into a first retention position with respect to the support plate and the mounting unit that maintains the support plate in a first rotational position at a first angle with respect to the mounting unit against the force of the first spring, the latch pin being further moveable into a second retention position with respect to the support plate and the mounting unit that maintains the support plate in a second rotational position at a second angle with respect to the mounting unit against the force of the first spring, the second angle being less than the first angle;
a release button moveably coupled with the latch pin and moveable outwardly from the housing with movement of the latch pin into the second position and moving the latch pin out of the second retention position on movement of the release button inwardly with respect to the housing.

2. The vehicle rearview, of claim 1, wherein the latch pin is slidably engaged with a first track in the support plate, the first track having a first end corresponding with the first retention position of the latch pin, a straight portion extending away from the first end generally parallel with the second end of the support plate, a curved portion extending toward the second end of the support plate, and a second end adjacent the curved portion and corresponding with the second retention position of the latch pin.

3. The vehicle rearview of claim 2, wherein the first end and the second end are respectively open to the first straight portion and the curved portion in a first direction disposed toward the substrate.

4. The vehicle rearview of claim 2, wherein the mounting unit defines a second track defining a straight portion immediately connected with a first end and a second end, the first end of the second track being alignable with the first end of the first track with the latch pin in the first retention position, and the second end of the second track being alignable with the second end of the first track with the latch pin in the second retention position.

5. The vehicle rearview of claim 1, wherein the release button is coupled with the latch pin so as to be retained in a retracted position with respect to the housing when the latch pin is in the first retention position and to be moved outwardly with respect to the housing into an extended position with movement of the latch pin into the second retention position.

6. The vehicle rearview of claim 5, wherein:
the release button defines a lower surface;
the support plate defines an outer surface with an aperture, the release button moveably positioned within the aperture; and
the lower surface of the release button is flush with the outer surface of the support plate when the release button is in the retraced position.

7. The vehicle rearview of claim 5, wherein the release button includes a visibility marking indicating orientation of the support plate in the second rotational position.

8. The vehicle rearview of claim 1, further including a damper operably coupled between the mounting unit and the support plate, the damper slowing movement of the support plate into the first rotational position from the second rotational position under force of the first spring.

9. The vehicle rearview of claim 1, further including a second spring coupled with the latch pin to urge the latch pin into the second retention position.

10. The vehicle rearview of claim 9, wherein the inward movement of the release button relative to the housing moves the latch pin out of the second retention position against the force of the second spring.

11. The vehicle rearview of claim 1, wherein:
the substrate includes a display panel having an active state and an inactive state;
the first rotational position of the support plate corresponds with the active state of the display panel; and
the second rotational position of the support plate corresponds with the inactive state of the display panel.

12. A vehicle rearview, comprising:
a substrate having a reflective surface thereon;
a housing coupled with the substrate; and
an actuation mechanism positioned within the housing and including:
a mounting unit;
a support plate coupled with the substrate opposite the reflective surface and having a first end rotatably coupled with the mounting unit and a second end spaced from the first end;
a spring abutting the mounting unit, at least partially received within a portion of the support plate, and urging the second end of the support plate away from the mounting unit;
a latch pin slidably engaged with the support plate and with the mounting unit and moveable into a first retention position with respect to the support plate and the mounting unit that maintains the support plate in a first rotational position at a first angle with respect to the mounting unit against the force of the spring, the latch pin being further moveable into a second retention position with respect to the support plate and the mounting unit that maintains the support plate in a second rotational position at a second angle with respect to the mounting unit against the force of the spring, the second angle being less than the first angle;
a release operably moving the latch pin out of the second retention position; and
a damper operably coupled between the mounting unit and the support plate, the damper slowing movement of the support plate into the first rotational position from the second rotational position under force of the first spring.

13. The vehicle rearview of claim 12, wherein the release is a button moveably coupled with the latch pin and moveable outwardly from the housing with movement of the latch pin into the second rotational position and moving the latch pin out of the second retention position on movement of the release button inwardly with respect to the housing.

14. The vehicle rearview of claim 13, wherein the release button is coupled with the latch pin so as to be retained in a retracted position with respect to the housing when the latch pin is in the first retention position and to be moved outwardly with respect to the housing into an extended position with movement of the latch pin into the second retention position.

15. The vehicle rearview of claim 14, wherein:
the release button defines a lower surface;
the support plate defines an outer surface with an aperture, the release button moveably positioned within the aperture; and
the lower surface of the release button is flush with the outer surface of the support plate when the release button is in the retraced position.

16. The vehicle rearview, of claim 12, wherein the latch pin is slidably engaged with a first track in the support plate, the first track having a first end corresponding with the first retention position of the latch pin, a straight portion extending away from the first end generally parallel with the second end of the support plate, a curved portion extending toward the second end of the support plate, and a second end adjacent the curved portion and corresponding with the second retention position of the latch pin.

17. The vehicle rearview of claim 16, wherein the first end and the second end are respectively open to the first straight portion and the curved portion in a first direction disposed toward the substrate.

18. The vehicle rearview of claim 16, wherein the mounting unit defines a second track defining a straight portion immediately connected with a first end and a second end, the first end of the second track being alignable with the first end of the first track with the latch pin in the first retention position, and the second end of the second track being alignable with the second end of the first track with the latch pin in the second retention position.

19. The vehicle rearview of claim 12, further including a second spring coupled with the latch pin to urge the latch pin into the second retention position; wherein the inward movement of the release button relative to the housing moves the latch pin out of the second retention position against the force of the second spring.

20. An actuation mechanism for a vehicle mirror comprising:
a mounting unit;
a support plate coupleable with a rearview substrate and having a first end rotatably coupled with the mounting unit and a second end spaced from the first end;
a first spring abutting the mounting unit, at least partially received within a portion of the support plate, and urging the second end of the support plate away from the mounting unit;
a latch pin slidably engaged with the support plate and with the mounting unit and moveable into a first retention position with respect to the support plate and the mounting unit that maintains the support plate in a first rotational position at a first angle with respect to the mounting unit against the force of the first spring, the latch pin being further moveable into a second retention position with respect to the support plate and the mounting unit that maintains the support plate in a second rotational position at a second angle with respect to the mounting unit against the force of the first spring, the second angle being less than the first angle;
a release button moveably coupled with the latch pin and moving the latch pin out of the second retention position on movement of the release button toward the mounting unit.
